(19) United States
(12) Patent Application Publication
(10) Pub. No.: US 2003/0005380 A1
(43) Pub. Date: Jan. 2, 2003

(54) Method and apparatus for testing multi-core processors

(76) Inventors: Hang T. Nguyen, Tempe, AZ (US); David E. Miner, Chandler, AZ (US)

Correspondence Address: KENYON & KENYON (SAN JOSE), 333 WEST SAN CARLOS ST., SUITE 600, SAN JOSE, CA, 95110, US

(21) Appl. No.: 09/895,695

(22) Filed: Jun. 29, 2001

(51) Int. Cl. H04L 1/22; H04B 1/74; H02H 3/05

(52) U.S. Cl. 714/736

(57) ABSTRACT

An apparatus and method for testing multi-core processors by simultaneously testing each of the multiple cores. The full vector of test results for a master core is sent to the test equipment for evaluation while the test results for the slave(s) are logically compared to those of the master, with the result of the comparison reduced to one or more bits.

### FIELD OF THE INVENTION

This invention is related to testing processor chips. More particularly, this invention relates to efficiently performing functional testing on multi-core processors in about the same amount of time required to test single core processors, and permitting use of the same test equipment.

### BACKGROUND OF THE INVENTION

Microprocessors have been shrinking in both size and cost, while simultaneously getting more powerful, for many years. Few expect this trend to significantly change anytime soon. Traditionally, many microprocessors have been fabricated on a single wafer. After fabrication, and some testing, the wafer is sliced yielding the many individual microprocessors.

Various computer architectures have used multiple processors within single computers since at least the 1970's and perhaps earlier. Such multiple processor computers could, for example, improve the availability of functioning hardware through redundancy or provide parallel data processing. A more recent trend, which somewhat parallels improvements in microprocessors, is toward fabrication with multiple microprocessors on a single die, typically for use in applications that require multiple processors. Such devices will be referred to as multi-core processors in the present specification, which will be distinguished from a single core processor.

The functional testing of processors is common industry practice because virtually no fabrication process yields 100%. Many test procedures and much test equipment have been developed for the functional testing of single core processors. In the context of this specification, the terms test and testing will refer to functional testing. It would be desirable to be able to utilize much of this existing stock of legacy test procedures, and test equipment, for testing multi-core processors.

One approach to test multi-core processors would be to test each of the cores individually, while the other cores on the die are temporarily “shut down.” This procedure could then be repeated until each core is tested. Even if there were no overhead cost, in either time or equipment, of sequentially testing each core of the multi-core processor, the time required for the testing would likely increase approximately linearly with the number of cores on the die. With the cost of testing already being a significant portion of the total cost to produce a single core microprocessor, any increase in the test time for each processor would likely be costly. For example, additional testing equipment, personnel, and floor space might be required in order to maintain the same level of production when the test time per processor increases. It would be desirable to minimize the extra time required to test multi-core processors.

A further complication of such sequential testing are the limits of existing equipment designed for testing a single core processors. During a typical test the processor is supplied a stream of code designed to test the many registers, logic units, and data paths of the processor. The processor's response, or the test output, takes the form of a series of electrical signals output to a bus or the processor pinout. The test equipment typically records the response in the form of vectors, which can be analyzed to determine whether or not the processor performance falls within the acceptable test performance criteria. However, existing (legacy) test equipment has a finite capacity, or vector memory depth, which may often roughly correspond to the capacity needed to test a single core processor. Thus, sequential testing of multi-core processors using test equipment with a limited vector memory depth may not proceed immediately without either evaluating the test results for the first core, or transferring the test results to another storage device, before proceeding to the subsequent test. In some situations it might be possible to upgrade the test equipment with additional memory, thus increasing the vector memory depth. However, this option could be expensive, and might even not be possible in all situations. It would be advantageous to avoid the memory constraints of legacy test equipment when testing multi-core processors.

The problems encountered testing multi-core processors compared to single core processors become apparent when only two cores are present on a single die. However, it is likely that the rapid advances in the field of microprocessors will soon lead to dies with more than two cores. It would be desirable to have a systematic approach to efficiently testing multi-core processors with any number of cores.

### BRIEF DESCRIPTION OF THE DRAWINGS

FIG. 1 is a block diagram of a dual-core processor, tested by an embodiment of the present invention.

FIG. 2 is a block diagram of another disclosure processor, tested by an embodiment of the present invention.

FIG. 3 depicts a flow chart of a procedure for testing dual-core processors in accordance with an embodiment of the present invention.

FIG. 4 is a block diagram of an N-core processor, tested by an embodiment of the present invention.

### DETAILED DESCRIPTION

Embodiments of the present invention may be used to test multi-core processors utilizing the test equipment and test procedures developed for testing single core processors, and do so in approximately the same amount of time required to test a single processor.

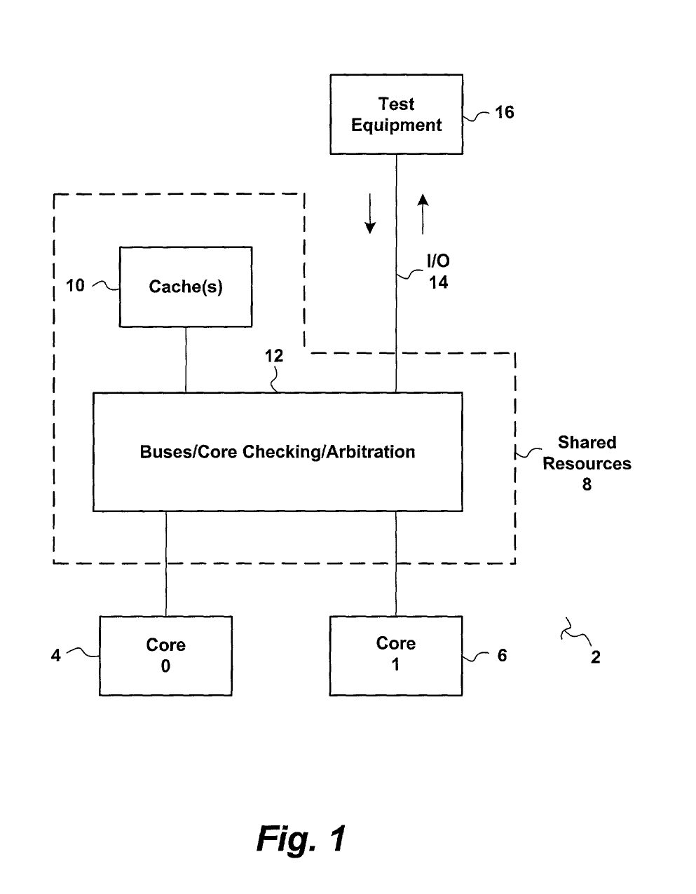

Turning now to FIG. 1, which shows one layout for a multi-core (dual-core) processor 2, with two cores, 4 and 6. Also shown are a set of shared resources 8 which may be associated with the multi-core processor. The shared resources may include one or more caches 10, a set of buses/core checking/arbitration (BCA) resources 12, and an I/O path 14, such as traces or a front side bus (FSB). Those of ordinary skill in the art will recognize that not all of these features are present, or necessary, on every multi-core processor. BCA 12 may include one or more buses between core 4, core 6, cache 10, core checking logic, and arbitration logic.

The core checking logic resources, if present, are typically used to compare the output from the multiple cores. For example, some multi-core processors used in error intolerant environments might operate in a redundant manner where both processors execute the same instruction set, and the core checking resources verify whether or not the two processors produce identical results. The present invention, as will be explained more fully below, compares the output from multiple cores. Some embodiments of the present invention may take advantage of core check functionality present within a multi-core processor, other embodiments may perform the comparison external to the processor.

Similarly, multi-core processors may have arbitration resources for some tasks, such as determining which of the processors may write to cache 10 or I/O path 14 at a particular point. For the purposes of the present disclosure, the cache(s) 10 and BCA resources 12 are effectively a black box which may be coupled to the multiple cores, and are located on the die with the cores, and with which the present invention may, or may not, need to interact.

One major concept of the present invention is allowing the testing of multiple cores simultaneously. The same test instruction set is supplied to all of the processor cores, with this full set of instructions processed by each core, while only a single test vector result, from a single “master” core, is output to the test equipment. To confirm the proper functional operation of the “slave” cores, a comparison is made between the master and the slave(s) to determine that the output of processing the test instruction set by each core is identical. As will be recognized by those of ordinary skill in the art, the terms “simultaneous” and “simultaneously” are used in the present disclosure in a broader sense than each core receiving a processing instructions in perfect logic-step. Rather, the present invention is intended to encompass embodiments in which an instruction might be processed by the multiple individual processors within a few clock cycles of each other, and the set of instructions is processed in essentially the same order by each individual processor. Similarly, the processing of instructions in parallel is intended to allow for deviation from lock-step synchronization of processing.

Using multi-core processor 2 in FIG. 1 as an example, the test instruction set is supplied to multi-core processor 2 along I/O path 14 in much the same way as would be done while testing a single processor core. The test instructions would then be routed to both cores 4 and 6, with one chosen as the master and the other as the slave.

The particular details of how the test instruction set is sent to both cores 4 and 6 in parallel, and the selection of the master and slave processors, are not within the scope of the present invention, and would likely vary with the particular multi-core processor architecture. Some embodiments of the present invention may be configured to work in conjunction with a particular BCA 12 so that some tasks, such as core checking, may be efficiently performed within the processor. Other embodiments of the present invention may include an external (to the processor) core checking module in which the output from the master core and from each of the slaves is fed into a logical XOR to detect any data discrepancy between the pair of cores for that particular step in processing the test instruction set. The use of XOR logic to compare two data streams is known to those of ordinary skill in the art.

If core 4 in FIG. 1 was selected as the master, and core 6 the slave, the test instructions would be processed by each simultaneously, with the results combined using a logical XOR, or similar technique, either within BCA 12 or within the test equipment 16. In order to reduce the memory required from that needed to store two full sets of test results, only the full set of test results for the master is stored in test equipment 16. Test results for core 6, the slave, are preferably represented by a single bit. That is, the logical XOR compared each of the individual test results of the two processors and flagged any discrepancies.

The results of the many XOR operations can be consolidated further in “sticky bit,” or single bit accumulate register, which is set to indicate any discrepancies between the master, core 4, and the slave, core 6. The resulting data from the simultaneous testing of cores 4 and 6 is a complete vector of test results for the master core, and a single bit indicating whether or not the slave produced identical test results. For the ideal case, in which both cores pass the functional test, examining the vector of test results (for the master) will confirm that the master tested successfully, and examining the sticky bit will confirm that the slave responded exactly like the master. This testing technique allows both cores to be functionally tested in about the same amount of time as a single core processor, and only requires the examination of one additional data bit when the test results are positive. Note that in addition to cutting the additional testing time to approximately zero, legacy test equipment and test procedures may easily be used with multi-core processors.

When the present invention is used to test multi-core processors with a relatively powerful BCA 12 system on the die, the test results for the slave core may not need to be transferred off the die via I/O path 14. Instead, the test results for each core could be fed into a logical XOR within multi-core processor 2, which might be further processed to create the sticky bit in an accumulate register on the die. In such an embodiment, multi-core processor 2 takes on much of the overhead of testing the additional core(s) so that from the frame of reference of test equipment 16, the testing procedure is virtually the same as testing a single processor. While the benefit of utilizing multi-core processor 2 for its own testing has benefits, it is also possible, to perform these same tasks, or some of these same tasks, off of multi-core processor 2 and external to test equipment 16. That is, I/O path 14 could be used to transfer the output from each of cores 4 and 6 off of multi-core processor 2 to a logical XOR processor, and the accumulate register. Creating this stand-alone checking functionality, in either hardware or software, is within the skill of those of ordinary skill in the art.

In order to perform the core checking and storage of the sticky bit within multi-core processor 2, the specific processor architecture would need to be considered. In particular, the details of shared resources 8 would typically vary widely among different multi-core processor designs. The present invention, however, is intended to work with virtually any multi-core processor architecture so that aspects of the testing such as core checking may be performed either on the die or in stand-alone test equipment.

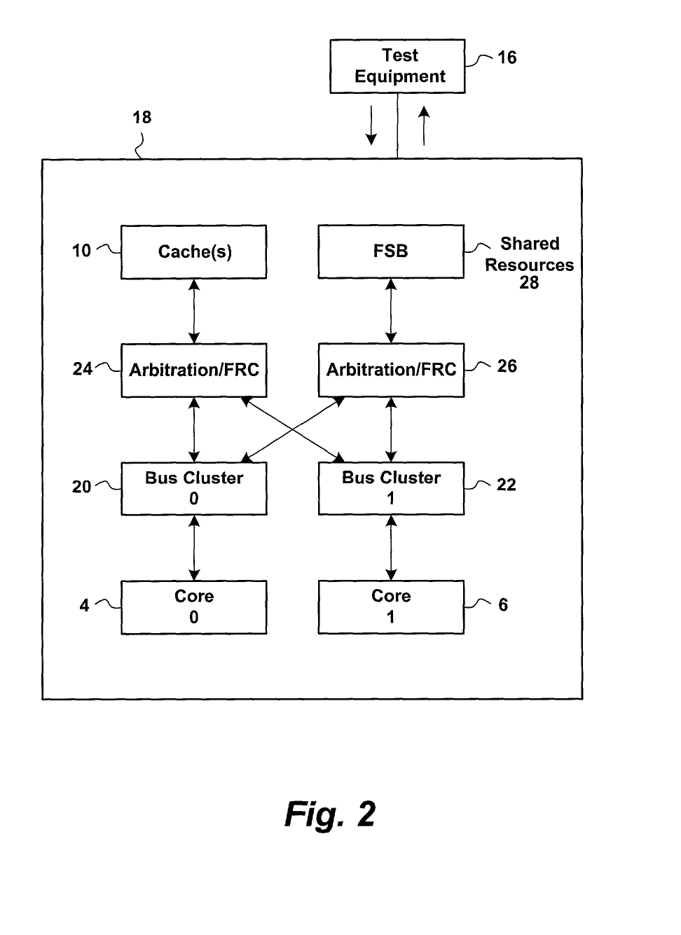

An embodiment of the present invention is adapted for testing multi-core processor 18, a specialized design shown in FIG. 2. Multi-core processor 18 is designed to run in one of two modes, either as a high performance dual-core processor or as a pair of identical cores in which each simultaneously performs operations on identical data streams. The latter mode enables processor 18 to provide a redundant processor core for tasks requiring a very high level of quality assurance, while the former allows using both processor cores independently for high data throughput.

Multi-core processor 18 has two cores, 4 and 6, two bus clusters, 20 and 22, each associated with one of the cores, two arbitration/FRC units, 24 and 26, interacting with either bus cluster, a cache 10, and a front side bus (FSB) 28. FSB 28 is functionally similar to I/O path 14, it provides an external link for multi-core processor 18. However, multi-core processor 18 only allows core 1, the master, to propagate data through to FSB 28 when it is performing in the redundant mode. Arbitration/FRC units 24 and 26 arbitrate the data transfers between bus clusters 20 and 22, cache 10, FSB 28, and they perform functional redundancy checks (FRC) duties for multi-core processor 18. Arbitration/FRC units 24 and 26 are capable of comparing the results of cores 4 and 6, as on-die core checking units, as well as performing much more sophisticated data checking, and may send data comparison results to an accumulate register in cache 10.

Thus, multi-core processor 18 differs somewhat from the architecture of multi-core processor 2, but both may be tested with the present invention so long as the data transfer onto the die and among the components on the die is carefully taken into account. In one embodiment, core 6 is used as a master, with core 4 the slave, the test instruction set is input through FSB 28, and provided to both cores 4 and 6 via arbitration/FRC unit 26 and bus clusters 20 and 22. The test results for core 6, the master, are returned to FSB and eventually to test equipment 16. The test results for core 4, the slave, are compared to those of core 6 within arbitration/FRC unit 24 with the comparison results saved as a single bit within cache 10. As was the case for testing multi-core processor 2, testing multi-core processor 18 does not take significantly longer than testing a single core processor, and the test data supplied to test equipment 16 does not significantly exceed that generated while testing a single core processor.

Functionally testing a dual-core processor results in one of four possible situations:

1. Both cores pass.

2. Master passes, slave fails.

3. Slave passes, master fails.

4. Both fail.

The first case should be the most common, and with the present invention this requires examining the resulting (positive) test vector within test equipment 16, just as would be the case of testing a single core processor, and confirming that the sticky bit shows the same vector was obtained for the slave. In this first case situation, the present invention allows for testing in about the same amount of time as when testing a single-core processor, on test equipment that might be used for testing a single-core processor, and examination of the same test vector. Examining the sticky bit, to effectively test the slave, would typically require very little time.

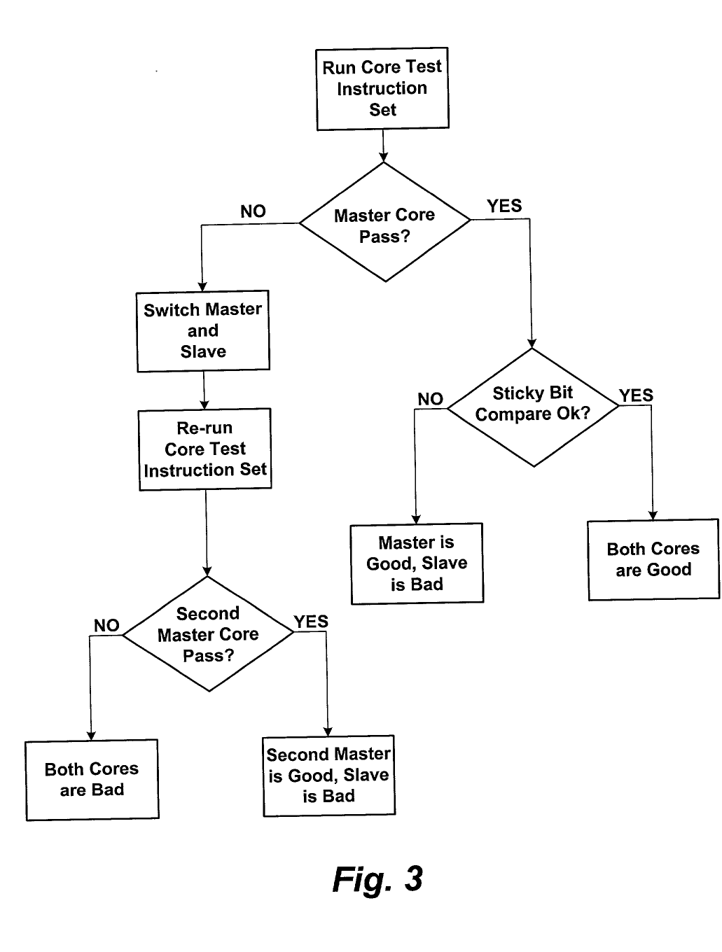

FIG. 3 is a flowchart showing the testing possibilities for a dual-core processor for each of the above four possible situations. Although having two properly functioning cores is the ideal result, there may still be value in multi-core processors with only a single (identified) properly functioning core. The present invention may be used to efficiently sort the multi-core processors into bins which each contain processors in one of the four above classifications.

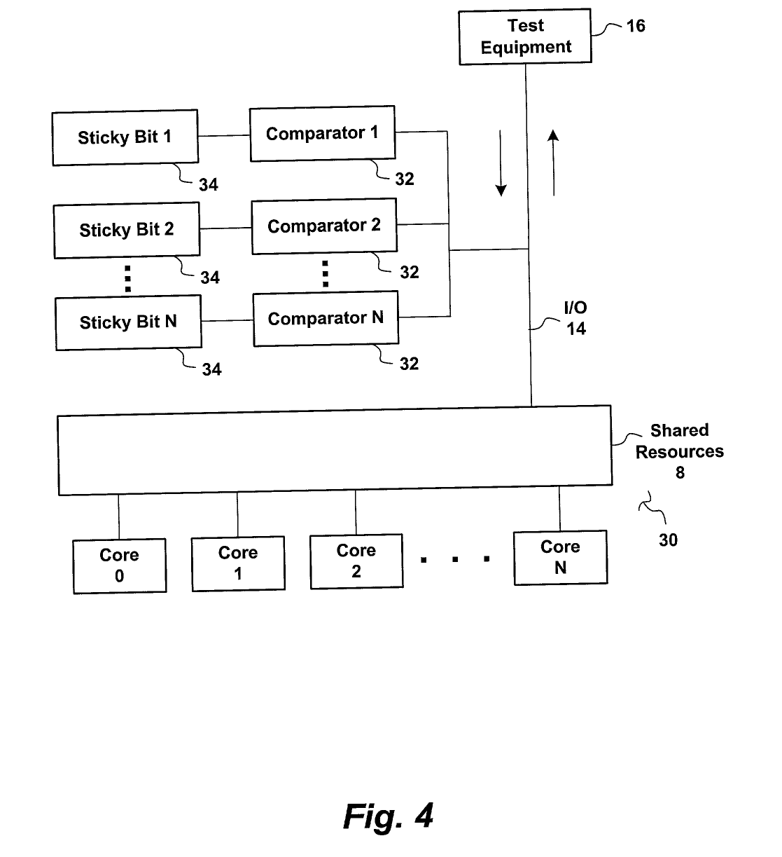

In addition to testing dual-core processors, the present invention may also be used to efficiently test processors containing three or more cores. FIG. 4 is a block diagram of an “N-core” processor 30. Like the above-described dual-core processor testing, the present invention sends the test instruction set through I/O path 14 to each of the individual-cores for parallel execution. The embodiment of the present invention in FIG. 4 shows a set of comparators 32, and sticky bit 34 registers, which are external to multi-core processor 30. Comparators 32 preferably each compare the test results of the master core with an individual slave core, producing a sticky bit representing whether or not the particular slave core matched the master core in the functional test. Such an embodiment obviously requires a large enough data capacity along I/O path 14 for transferring the test results from each of the processors. Another embodiment of the present invention would read the test vector results as they are output by each core, before these signals leave multi-core processor 30, in order to minimize the amount of data along I/O path 14. For example, if multi-core processor 30 were designed with output pads at each core, comparators 32 and sticky bit 34 registers could be connected to such pads and the amount of data that needed to be transferred through I/O path 14 would be reduced greatly. Other embodiments of the present invention might utilize shared resources 8 instead of requiring an external set of comparators 32, and sticky bits 34, thus requiring less data to be transferred off the die through I/O path 14. Sticky bits 34 may also be combined into an array representing a compare result for each core identified by the bit location within the array.

Those of ordinary skill in the art will be able, with the benefit of the present disclosure, to see how the process shown in FIG. 3 would need to be modified to categorize the test results for a group of N-core processors.

Other embodiments of the present invention would include additional sets of comparators 32 so that a particular core could be compared to multiple other cores, instead of a single master core. Such an embodiment would permit the quicker determination of which core(s) are good and which are bad than would be the case of requiring N different tests with N different master cores.

While embodiments and applications of this invention have been shown and described, it would be apparent to those skilled in the art, after a review of this disclosure, that many more modifications than mentioned above are possible without departing from the inventive concepts herein. The invention, therefore, is not to be restricted except in the spirit of the appended claims.

What is claimed is:

1. An apparatus for testing multi-core processors, comprising:
a test input connector electrically coupled to a master processor and a slave processor for simultaneously providing a test signal to said master and said slave processors;
a test output connector electrically coupled to said master processor for monitoring a master processor test result; and
a comparator electrically coupled to said master processor and said slave processor for comparing said master processor test result and a slave processor test result and storing a match result.

2. An apparatus in accordance with claim 1, wherein:
said comparator uses a single bit for comparing said master processor test result and said slave processor test result.

3. An apparatus in accordance with claim 1, further comprising:
a multi-core test reporter coupled to said test output connector and coupled to said comparator for reporting a result of said master processor test result and said match result.

4. An apparatus in accordance with claim 1, wherein:
said master processor and said slave processor are present on a single die.

5. An apparatus for testing multi-core processors, comprising:
a test input connector electrically coupled to a master processor and a plurality of slave processors simultaneously providing a test signal to said master and said slave processors;
a test output connector electrically coupled to said master processor for monitoring a master processor test result;
a comparator electrically coupled to said master processor and said plurality of slave processors for comparing said master processor test result and a plurality of slave processor test result and storing a match result.

6. An apparatus in accordance with claim 1, wherein:
said comparator uses one bit for comparing each of said plurality of slave processors to said master processor.

7. An apparatus in accordance with claim 1, wherein:
said master processor and said plurality of slave processors are present on a single die.

8. An apparatus in accordance with claim 1, further comprising:
a multi-core test reporter coupled to said test output connector and coupled to said comparator for reporting a result of said master test result and said match result.

9. An apparatus for testing multi-core processors with internal core checking logic, comprising:
a test input connector electrically coupled to a master processor and a slave processor for simultaneously providing a test signal to said master and said slave processors;
a test output connector electrically coupled to said master processor for monitoring a master test result;
a core checking logic driver for controlling the internal core checking logic and reporting a deviation between said master and said slave in response to said test signal.

10. An apparatus in accordance with claim 9, wherein:
said master processor and said slave processor are present on a single die.

11. An apparatus in accordance with claim 9, further comprising:
a multi-core test reporter coupled to said test output connector and coupled to said core checking logic driver for reporting a result of said master test result and said deviation.

12. A method for testing multi-core processors, comprising:
running a functional test on each of a plurality of processors simultaneously;
monitoring said functional test results on a first processor;
comparing said functional test results on said first processor with said functional test results on a second processor and creating a first match result and;
reporting said functional test results on said first processor and said first match result.

13. A method in accordance with claim 12, further comprising:
repeating said functional test on said second processor when said first processor fails said functional test.

14. A method in accordance with claim 12, wherein:
creating said first match result uses a single bit accumulate register.

15. A method of testing in accordance with claim 12, wherein:
said comparing of functional test results is performed on the multi-core processor.

16. A method of testing in accordance with claim 12, wherein:
said comparing of functional test results is performed externally to the multi-core processor.

17. A method of testing in accordance with claim 12, wherein:
creating said first match result is performed on the multi-core processor.

18. A method of testing in accordance with claim 12, wherein:
creating said first match result is performed externally to the multi-core processor.

19. A method of testing in accordance with claim 12, further comprising:
comparing said functional test results on said first processor with said functional test results on a third processor;
creating a second match result and;
reporting said second match result.

20. A multi-core processor testing system, comprising:
supplying a test instruction set to the multi-core processor for execution on a plurality of cores;
receiving a test vector representing the execution of said test instructions by a first core;
comparing the execution of said test instruction by a second core with said test vector;
creating a slave condition bit from said comparing step.

21. A system in accordance with claim 20, further comprising:
reporting a quality condition status for the multi-core processor.
